(19) United States
(12) Patent Application Publication
(10) Pub. No.: US 2019/0346803 A1
(43) Pub. Date: Nov. 14, 2019

(54) IMAGE FORMING SYSTEM

(71) Applicant: KONICA MINOLTA, INC., Tokyo (JP)

(72) Inventors: Teruhiko TOYOIZUMI, Tokyo (JP); Tatsuo ISHIZUKA, Tokyo (JP); Hirofumi NAKAJIMA, Tokyo (JP); Akira OKAMOTO, Tokyo (JP)

(73) Assignee: KONICA MINOLTA, INC., Tokyo (JP)

(21) Appl. No.: 16/376,702

(22) Filed: Apr. 5, 2019

(30) Foreign Application Priority Data
May 11, 2018 (JP) 2018-092213

(51) Int. Cl. G03G 15/00

(52) U.S. Cl. CPC G03G 15/6582; G03G 15/5029; G03G 2215/00025; G03G 2215/00818; G03G 15/5016

(57) ABSTRACT

An image forming system includes: an image forming apparatus that forms an image on a sheet; and a post-processor including a punch unit that forms a punch hole on the sheet conveyed from the image forming apparatus, wherein the image forming apparatus includes a conveyance control part that controls conveyance of the sheet to be conveyed to the post-processor, and the punch unit includes: a perforating part that forms the punch hole on the sheet; a detection part that performs sheet side end portion detection for detecting a side end portion in a main scanning direction, and paper dust detection for detecting a paper dust amount in a detection region; a swinging part that moves the perforating part to an arbitrary position; and a hardware processor that, when a punch job is performed, controls the detection part to perform the paper dust detection.

The entire disclosure of Japanese patent Application No. 2018-092213, filed on May 11, 2018, is incorporated herein by reference in its entirety.

### BACKGROUND

### Technological Field

The present invention relates to an image forming system including an image forming apparatus that forms an image on a sheet and a punch unit that forms a punch hole on the sheet.

### Description of the Related Art

In recent years, image forming systems including a plurality of post-processors having various functions such as a side stitch binding machine, a punch unit, and a case binding machine have become widespread. A punch unit is often coupled to the most downstream of an image forming system. Therefore, the conveyance distance of a sheet from the image forming apparatus to the punch unit becomes long, and when the sheet reaches the punch unit, positional deviation of the sheet in a main scanning direction (hereinafter referred to as a sheet width direction) orthogonal to a conveyance direction is likely to occur.

In a conventional punch unit, in order to solve deviation of a punch position due to the positional deviation of the sheet, a passage position at a side end portion of the sheet is detected by a sensor, and control for correcting the punch position is performed on the basis of data of this detection. For example, an image forming system including a sheet detection sensor that detects a side end portion position of a sheet, and a perforating part disposed on a downstream side in a sheet conveyance direction of the sheet detection sensor, in which a deviation amount of a side end portion position of the sheet is measured by the sheet detection sensor, and a perforating part is moved on the basis of the measured deviation amount of the side end portion position has been proposed (see, for example, JP 2006-240790 A and JP 2014-47023 A).

As a method of detecting the side end portion position of the sheet, an image forming system using a solid-state imaging element such as a charge coupled device (CCD) image sensor has been proposed (for example, see JP 2017-167302 A). In this image forming system, it is possible to correctly detect a position of an end portion of a sheet even in a post-printed sheet in which an image is already formed, in an image forming part. Therefore, even in the case where the positional deviation of the sheet occurs in the image forming part, it is possible to form an image at a correct position.

However, in image forming systems disclosed in JP 2006-240790 A and JP 2014-47023 A, a sheet detection sensor attached to a punch unit is swung to detect a sheet side end portion for each sheet, and operation for matching a punch position is performed on the basis of detection data. In this method, time for swinging the sheet detection sensor from the position where no sheet exists to the side end portion position of the sheet, time for swinging the punch unit from the side end portion position of the sheet to the punch hole formation position of the sheet, and time for returning the punch unit to the position where the initial sheet does not exist after formation of the punch hole are required for each sheet, and therefore, the productivity of the image forming system decreases in forming of a punch hole.

On the other hand, when an image sensor or the like is used for a sheet detection sensor, the image sensor is fixed on a sheet conveyance path so that the swinging time of the sensor is eliminated and the time to detect the sheet side end portion can be reduced. However, when the image sensor is used, if paper dust adheres to a detection surface, it is erroneously detected that the sheet exists due to the paper dust. Thus, paper dust detection needs to be performed. Unlike a case where a sheet side end portion is detected at a place only for conveyance of a sheet such as an image forming part disclosed in JP 2017-167302 A, in a post-processor that forms a punch hole, the influence of paper dust tends to be remarkable. Therefore, in a post-processor that forms a punch hole, paper dust is easily detected during job execution, making it easy to erroneously detect paper dust and a sheet. For this reason, in a post-processor using an image sensor for sheet side end portion detection, the post-processor often stops due to erroneous detection of the sheet side end portion due to paper dust, and the productivity decreases. There is an influence that the positional accuracy of a punch hole tends to be low due to erroneous detection of the sheet side end portion position due to paper dust.

### SUMMARY

In order to solve the above problem, the present invention provides an image forming system capable of suppressing a decrease in productivity and capable of detecting a side end portion position of a sheet, in a post-processor.

To achieve the abovementioned object, according to an aspect of the present invention, an image forming system reflecting one aspect of the present invention comprises: an image forming apparatus that forms an image on a sheet; and a post-processor coupled to a downstream side of the image forming apparatus and including a punch unit that forms a punch hole on the sheet conveyed from the image forming apparatus, wherein the image forming apparatus comprises a conveyance control part that controls conveyance of the sheet to be conveyed to the post-processor, and the punch unit of the post-processor comprises: a perforating part that forms the punch hole on the sheet; a detection part that performs sheet side end portion detection for detecting a side end portion in a main scanning direction orthogonal to a conveyance direction of the sheet conveyed from the image forming apparatus using a predetermined detection threshold, and paper dust detection for detecting a paper dust amount in a detection region using a predetermined detection threshold; a swinging part that moves the perforating part to an arbitrary position on the basis of a position of the side end portion of the sheet obtained by a detection result of the detection part; and a hardware processor that, when a punch job is performed, controls the detection part to perform the paper dust detection using a timing different from a timing in the sheet side end portion detection, and a detection threshold different from the detection threshold in the sheet side end portion detection.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing an example of a configuration of an image forming system;

FIG. 2 is a diagram schematically showing a configuration of a main portion of a punch unit in a main surface direction of a sheet;

FIG. 3 is a diagram schematically showing a configuration of a main portion of a punch unit in a side surface direction of a sheet;

FIG. 4 is a diagram showing an example of a block configuration of the image forming system;

FIG. 5 is a diagram showing an example of detection signals of a side end portion of a sheet and paper dust by a detection part;

FIG. 6 is a diagram showing a relationship of a detection signal output from the detection part, a sheet detection threshold, and a paper dust detection threshold;

FIG. 7 is a diagram showing a flowchart of paper dust detection operation in punch processing; and

FIG. 8 is a table showing an example for determining execution of cleaning display from the number of job sheets and an estimated paper dust amount.

### DETAILED DESCRIPTION OF EMBODIMENTS

Hereinafter, one or more embodiments of the present invention will be described with reference to the drawings. However, the scope of the invention is not limited to the disclosed embodiments.

### Embodiment of Image Forming System

Specific embodiments of a semiconductor device of the present invention will be described below.

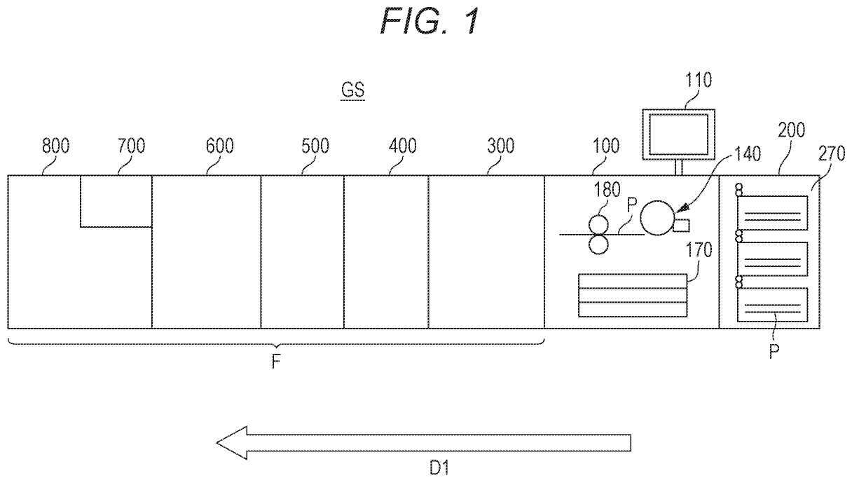

FIG. 1 shows an example of a configuration of an image forming system GS. The image forming system GS includes an image forming apparatus 100, a large-capacity sheet feeder 200, and a plurality of post-processors F, and these apparatuses are coupled along a sheet conveyance direction D1. In the image forming system GS, when punch processing is performed in a punch unit 700, in a detection part fixed to a sheet conveyance path, sheet side end portion detection for detecting a side end portion in a main scanning direction orthogonal to the sheet conveyance direction, and paper dust detection for detecting the paper dust amount in a detection region are performed. At that time, the detection part performs the sheet side end portion detection and the paper dust detection with different timings and with different detection thresholds.

[Configuration of Image Forming Apparatus]

In the image forming system GS, the image forming apparatus 100 includes an operation display part 110, an image forming part 140, a sheet feeding part 170, and a fixing part 180. Note that, since a well-known image forming apparatus can be applied as the image forming apparatus 100, a detailed description of the configuration of the image forming apparatus 100 will be omitted below.

In the image forming apparatus 100, the operation display part 110 is installed on an upper surface portion of a housing included in the image forming apparatus 100, and has: a touch panel including a liquid crystal display (LCD) or the like that can be operated by touch operation; and a hard key including various buttons such as a numeric key or a start button. The operation display part 110 receives input operation by a user of image forming conditions such as a sheet size or a sheet feed tray, processing conditions of the post-processor F, or the like. The operation display part 10 also displays various types of information of the state of the image forming system GS for notifying a user, the state of each configuration, or the like.

The sheet feeding part 170 has a plurality of sheet feed trays that accommodate various types of sheets P such as A4 size or A3 size. When the start of image forming processing is selected in the operation display part 110 or the like, the sheet feeding part 170 takes out the sheet P from the sheet feed tray by a pickup roller, a handling roller, or the like. Then, the taken-out sheet P is conveyed one by one to the image forming part 140 by a conveyance roller or the like.

The image forming part 140 includes a charging part, a photoreceptor, an exposure part, and a developing part (not shown). After an electric charge is added to the photoreceptor by the charging part, a laser light is emitted from the exposure part to form an electrostatic latent image on the photoreceptor. Then, the developing part visualizes the electrostatic latent image on the surface of the photoreceptor to form a toner image. Thereafter, the toner image is transferred onto an intermediate transfer belt, and the toner image transferred to the intermediate transfer belt is transferred onto the surface of the sheet P conveyed at a predetermined timing. The sheet to which the image has been transferred is conveyed to the fixing part 180 installed on the downstream side in the sheet conveyance direction D1 of the image forming part 140.

The fixing part 180 includes, for example, a pressure roller, a fixing roller, a belt, or the like, and heats and pressurizes the sheet P conveyed from the image forming part 140, thereby fixing a toner image on the sheet P. The sheet P subjected to the fixing processing in the fixing part 180 is conveyed toward each post-processor F specified by the user.

[Configuration of Large-Capacity Sheet Feeder]

In the image forming system GS, a large-capacity sheet feeder 200 is coupled to the upstream side in the sheet conveyance direction D1 of the image forming apparatus 100, and includes a sheet feeding part 270 including a plurality of stages of sheet feed trays or the like for accommodating a large amount of sheets P in the inside of a casing. The sheet feeding part 270 accommodates sheets P of the same size or different sizes. The large-capacity sheet feeder 200 includes an air blowing part, a suction conveyance part, a conveyance roller, or the like (not shown). When the printing processing is started, the sheet specified by a print job is separated and taken out one by one from the sheet feed tray by the air blowing part, the suction conveyance part, or the like, and conveyed to the upstream side image forming apparatus 100 via the conveyance roller or the like. When the sheet P in the sheet feeding part 270 currently being fed is exhausted, the sheet feeding part 270 switches to another sheet feeding part 270 accommodating sheets P of the same size, and feeding is continued. In the image forming system GS according to the present embodiment, one large-capacity sheet feeder 200 is provided. However, the present invention is not limited to this, and two or more large-capacity sheet feeders 200 may be coupled and provided.

[Configuration of Post-Processor]

In the image forming system GS, the post-processor F includes, for example, a curl correcting device 300, a two-sheet laminating machine 400, a stacking machine 500, a case binding machine 600, a punch unit 700, and a side stitch binding machine 800. Each of these devices can be used independently, or a plurality of devices can be used in combination. For example, it is possible to use only the punch unit 700 alone, or to use the punch unit 700 to form a punch on the sheet P after correcting the curl on the sheet P by the curl correcting device 300.

The curl correcting device 300 is coupled to the downstream side in the sheet conveyance direction D1 of the image forming apparatus 100, and corrects the curl of the sheet P conveyed from the image forming apparatus 100. The two-sheet laminating machine 400 is coupled to the downstream side of the curl correcting device 300 in the sheet conveyance direction D1, and performs two-sheet laminating processing of the sheet P conveyed one by one from the image forming apparatus 100. The stacking machine 500 is coupled to the downstream side in the sheet conveyance direction D1 of the two-sheet laminating machine 400, and stacks the sheet P conveyed one by one from the image forming apparatus 100 in units of a plurality of sheets. The case binding machine 600 is coupled to the downstream side of the stacking machine 500 in the sheet conveyance direction D1, and performs case binding processing on a plurality of sheets P conveyed from the image forming apparatus 100.

The side stitch binding machine 800 is coupled to the downstream side of the sheet conveyance direction D1 of the case binding machine 600, that is, the most downstream side of the image forming system GS, and performs side stitch binding processing on a plurality of sheets P conveyed from the image forming apparatus 100. The punch unit 700 is configured to be incorporated in the side stitch binding machine 800. The punch unit 700 forms a punch hole on the sheet P conveyed from the image forming apparatus 100. Note that the punch unit 700 can be configured as a single device, not a built-in type. The position of the punch unit 700 can also be disposed at an arbitrary position such as on the downstream side of the curl correcting device 300.

[Configuration Example of Punch Unit]

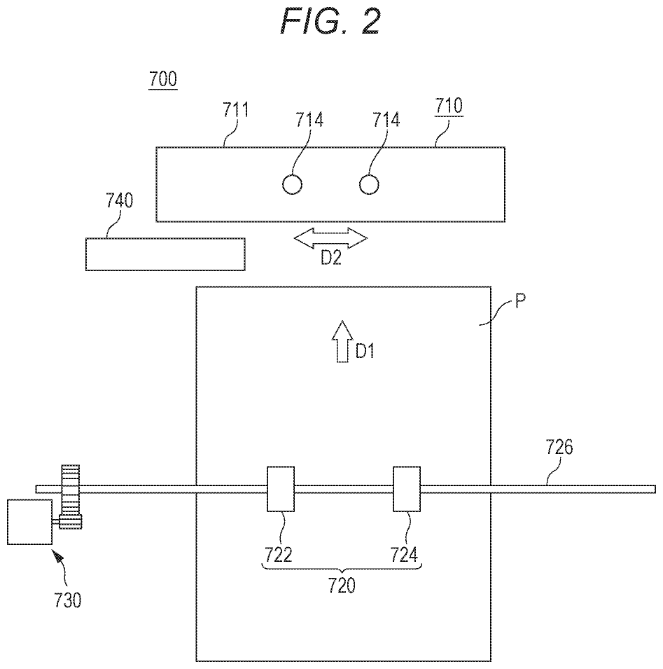

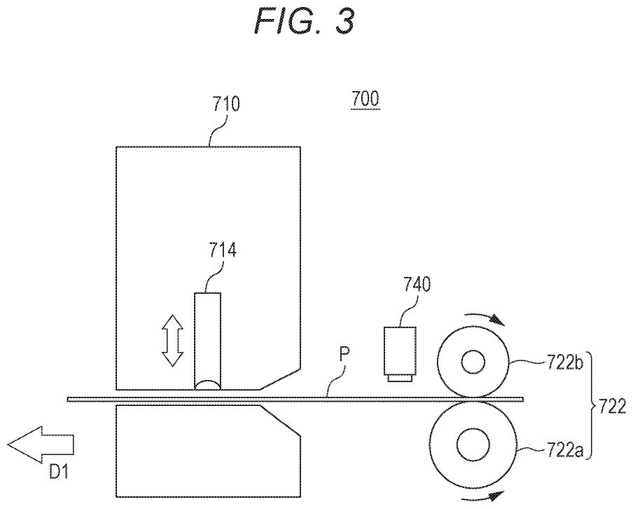

Next, the punch unit 700 will be described. FIG. 2 schematically shows a configuration of a main portion of the punch unit 700 in a main surface direction of a sheet on which punch processing is performed. FIG. 3 schematically shows a configuration of a main portion of the punch unit 700 in a side surface direction of a sheet on which punch processing is performed.

As shown in FIGS. 2 and 3, the punch unit 700 includes a perforating unit 710, a conveyance pan 720, a roller driving part 730, and a detection part 740.

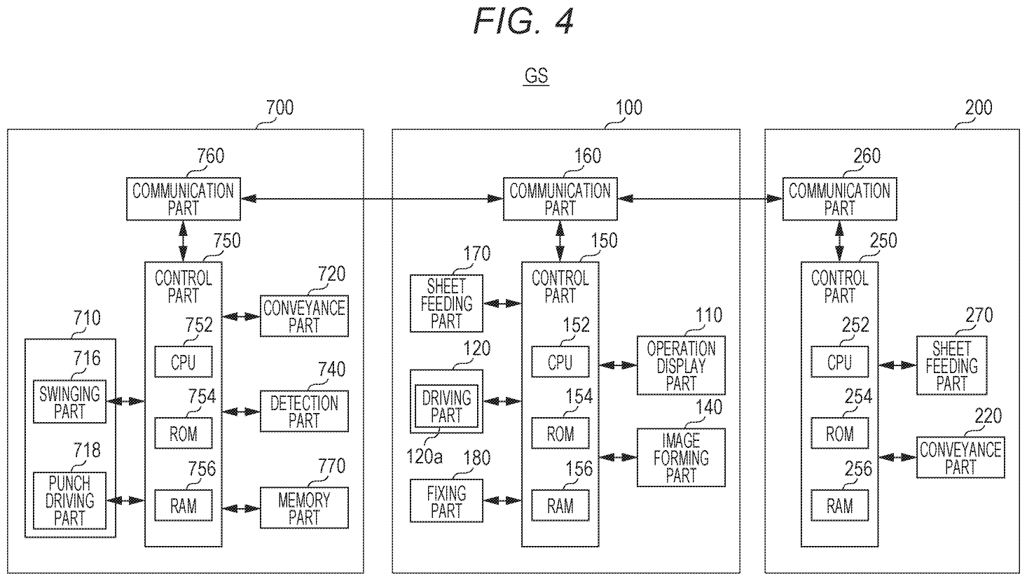

The perforating unit 710 includes a unit main body 711 and a perforating part 714. The unit main body 711 is an elongated casing extending in a sheet width direction D2, and is integrally formed with the perforating part 714 incorporated in the inside thereof and reciprocates (swings) along the sheet width direction D2 by being driven by a swinging part 716 (see FIG. 4).

In the punch unit 700, the perforating unit 710 is preferably disposed such that the perforating part 714 is located inside the both side end portions of the sheet P in the main scanning direction (sheet width direction D2) orthogonal to the sheet conveyance direction D1. That is, it is preferable that the perforating unit 710 be located within the above-described arrangement both when performing the punch operation and when not performing the punch operation. By locating the perforating unit 710 within the above-described arrangement, the moving distance of the perforating unit 710 at the time of performing the punch operation is shortened, and the time from the start of swinging of the perforating unit 710 to the completion of the punch hole formation is shortened. Therefore, a reduction in productivity of the punch unit 700 can be suppressed.

The perforating part 714 is configured to be movable in the direction of the sheet P from the perforating unit 710 by a punch driving part 718 (see FIG. 4) (not shown), and punches the sheet P at a predetermined position to form a punch hole on the sheet P. The perforating part 714 includes, for example, two punch blades, and these punch blades are provided at a predetermined interval along the longitudinal direction of the perforating unit 710. The perforating part 714 moves to the punch position together with the unit main body 711 by the swinging of the perforating unit 710 during the punch operation. Then, the punch blade of the perforating part 714 moves in the vertical direction, and a punch hole (through hole) is formed on the sheet P.

The conveyance part 720 has a conveyance roller 722, a conveyance roller 724, and a rotation shaft 726 that couples the conveyance roller 722 and the conveyance roller 724. The conveyance roller 722 and the conveyance roller 724 are disposed on the further upstream side in the sheet conveyance direction D1 than the perforating unit 710, and are disposed on the rotation shaft 726 with a predetermined interval in the sheet width direction D2. The conveyance part 720 conveys the sheet P conveyed from the image forming apparatus 100 via the case binding machine 600 or the like to the punch position of the perforating unit 710. As shown in FIG. 3, the conveyance roller 722 includes a driving roller 722a and a driven roller 722b. Note that, although not shown, the conveyance roller 724 also includes a driving roller and a driven roller as similar to the conveyance roller 722.

The roller driving part 730 includes a driving device such as a stepping motor, for example, and is attached to the rotation shaft 726 of the conveyance part 720 via a gear or the like. When the roller driving part 730 is driven, the rotation shaft 726 and the conveyance roller 722 and the conveyance roller 724 attached to the rotation shaft 726 rotate to convey the sheet P in the sheet conveyance direction D1.

(Configuration Example of Detection Part)

The detection part 740 mounted on the punch unit 700 includes, for example, a reflection type sensor (photosensor). The detection part 740 performs sheet side end portion detection for detecting the side end portion in the main scanning direction (the sheet width direction D2) orthogonal to the sheet conveyance direction, and paper dust detection for detecting the paper dust amount in the detection region.

In the detection part 740, an output signal rises when the sheet P or paper dust is detected, an output signal falls when the sheet P or paper dust is not detected, and the result is transmitted to the control part (see FIG. 4). Accordingly, while the sheet P passes through the detection part 740, the output signal from the detection part 740 maintains a constant value. While the detection part 740 is performing the paper dust detection, the output signal of the portion in which the paper dust is detected maintains a constant value.

A reflection type sensor included in the detection part 740 includes, for example, a light emitting part, a light receiving part, and a photoelectric conversion part. In the reflection type sensor, the light emitting part emits light onto the sheet P along an orthogonal direction orthogonal to the conveyance direction of the sheet P. Further, the light receiving part includes, for example, a line sensor formed by arranging a contact image sensor (CIS) in a horizontal row. The light receiving part receives the incident light including the light emitted from the light emitting part onto the sheet P and reflected from the sheet P. The photoelectric conversion part photoelectrically converts incident light received by the light receiving part into a detection signal.

The detection part 740 is installed in the downstream side of the conveyance part 720 in the sheet conveyance direction D1 and in the upstream side of the punch unit 700. The detection part 740 is attached at one end portion in the main scanning direction orthogonal to the sheet conveyance direction D1 of the sheet P so as to face the front surface side of the sheet P.

It is preferable that the detection part 740 be fixedly provided at a position in which the side end portion position in the direction orthogonal to the sheet conveyance direction D1 of the sheet P is included in the detection region, on various types of sheets P used in the image forming system GS. By disposing the detection part 740 at this position, it is possible to detect the side end portion of the sheet P without swinging the detection part 740, the perforating unit 710, or the like. It is unnecessary to take time to swing the detection part 740, the perforating unit 710 or the like, so that it is possible to suppress a decrease in productivity of the punch unit 700. It is preferable that the punch unit 700 include the detection part 740 whose side end portion position is within the detection region with respect to all the sheets from the maximum size to the minimum size. However, the punch unit 700 may include a plurality of detection parts 740 according to the sheet size.

[Block Configuration Example of Image Forming System]

Next, a block configuration example of the image forming system GS will be described. FIG. 4 shows an example of a block configuration of the image forming system GS. Note that, in FIG. 4, only the block configurations of the image forming apparatus 100, the large-capacity sheet feeder 200, and the punch unit 700 are shown, and the description of the block configurations of the other post-processors is omitted.

(Block Configuration of Image Forming Apparatus)

The image forming apparatus 100 includes a control part 150 that controls the operation of the entire system. The control part 150 includes a central processing unit (CPU) 152, a read only memory (ROM) 154, and a random access memory (RAM) 156. The CPU 152 develops programs and data read from the ROM 154 on the RAM 156 and executes them to control image forming processing, and operation of the post-processor F including the large-capacity sheet feeder 200 and the punch unit 700.

To the control part 150, each of the operation display part 110, the image forming part 140, the sheet feeding part 170, the conveyance part 120, the communication part 160, and the fixing part 180 is connected. The operation display part 110 receives image forming conditions such as a sheet size or a sheet type, receives selection information, punch conditions, or the like of the punch unit 700, and supplies an operation signal based on the received input information to the control part 150.

The image forming part 140 performs charging, exposure, development processing, speed control of an intermediate transfer belt or the like on the basis of instructions from the control part 150. The sheet feeding part 170 takes out the sheet P one by one from a sheet feed tray corresponding to the sheet P selected by the user on the basis of an instruction from the control part 150, and supplies the sheet P to the image forming part 140. For example, when punch processing is performed on the first sheet, the control part 150 may control the sheet feeding timing of the sheet P from the sheet feeding part 170 such that the interval between the first sheet and the second sheet is longer than the interval of the second and subsequent sheets.

The conveyance part 120 has a driving part 120a for driving a plurality of conveyance rollers installed in a conveyance path. The driving part 120a includes a stepping motor, for example, and is driven on the basis of a driving signal supplied from the control part 150. When the punch processing is performed, the control part 150 controls the operation of the driving part 120a such that the interval between the first sheet to be punched and the second sheet is longer than the interval of the second and subsequent sheets.

The communication part 160 includes various interfaces such as a network interface card (NIC), a modulator-demodulator (MODEM), or a universal serial bus (USB), and is connected to the communication part 260 of the large-capacity sheet feeder 200, and the communication part 760 of the punch unit 700 via the plurality of post-processors F. The communication part 160 bidirectionally communicates with the large-capacity sheet feeder 200 and the punch unit 700 to transmit and receive information related to sheet feeding and information related to punch processing.

(Block Configuration of Large-Capacity Sheet Feeder)

The large-capacity sheet feeder 200 includes a conveyance part 220, a sheet feeding part 270, a control part 250, and a communication part 260. The sheet feeding part 270 controls the air blowing part, the suction conveyance part, or the like to take out the sheet P one by one from a sheet feed tray corresponding to the sheet P selected by the user on the basis of an instruction from the control part 250. The conveyance part 220 includes, for example, a plurality of conveyance rollers and is driven on the basis of a driving signal supplied from the control part 250, and conveys the sheet P taken out from the sheet feeding part 270 to the image forming apparatus 100.

The control part 250 includes a CPU 252, a ROM 254, and a RAM 256, and controls operation of the conveyance part 220 and the sheet feeding part 270 on the basis of an instruction from the control part 150 of the image forming apparatus 100. When the punch processing is performed, the control part 250 controls the operation of the conveyance part 220 and the sheet feeding part 270 to adjust the sheet feeding timing such that the interval between the first sheet and the second sheet is longer than the interval of the second sheet and the subsequent sheet.

(Block Configuration of Punch Unit)

The punch unit 700 includes a perforating unit 710, a conveyance part 720, a detection part 740, a memory part 770, a control part 750, and a communication part 760. The perforating unit 710 includes a swinging part 716 and a punch driving part 718.

The detection part 740 detects a side end portion of the sheet P conveyed from the image forming apparatus 100 on the basis of an instruction from the control part 750, and supplies a sheet detection signal obtained by detection to the control part 750. The detection part 740 detects the paper dust in the detection region on the basis of an instruction from the control part 750, and supplies the paper dust detection signal obtained by the detection to the control part 750.

The swinging part 716 includes, for example, a stepping motor, a gear, or the like, and moves the perforating unit 710 to the punch position on the basis of a driving signal supplied from the control part 750. When the punch operation is completed, the swinging part 716 moves the perforating unit 710 from the punch position to the original position. Note that the mechanism of the swinging part 716 is not limited to the above configuration, and various mechanisms using a belt, a rail, or the like can be adopted. The punch driving part 718 includes, for example, a motor, a gear, or the like, and moves the perforating part 714 in the vertical direction on the basis of the driving signal supplied from the control part 750.

The conveyance part 720 includes a stepping motor or the like for driving the conveyance rollers 722, 724, and is driven on the basis of a driving signal supplied from the control part 750 to rotate the conveyance rollers 722, 724 to convey the sheet P to the punch position.

The memory part 770 includes a nonvolatile semiconductor memory, a hard disk drive (HDD), or the like, and stores information such as the reference movement distance to the punch position of the perforating unit 710, or the detection position information of the side end portion of the sheet P detected by the detection part 740.

The control part 750 includes a CPU 752, a ROM 754, and a RAM 756, and controls operation of the perforating unit 710, the conveyance part 720 and the detection part 740 on the basis of an instruction from the control part 150 of the image forming apparatus 100. When the punch processing of the sheet P is performed, after the sheet P stops at the punch position and vibration of the perforating unit 710 stops or is attenuated, the control part 250 controls operation of the punch driving part 718 of the perforating unit 710 so as to perform punch operation.

The control part 250 acquires output data of the paper dust detection signal detected by the detection part 740, and calculates the paper dust amount. Then, the control part 250 determines whether or not cleaning of the paper dust in the punch unit 700 is necessary, from the calculated paper dust amount.

[Detection of Sheet Side End Portion and Detection of Paper Dust]

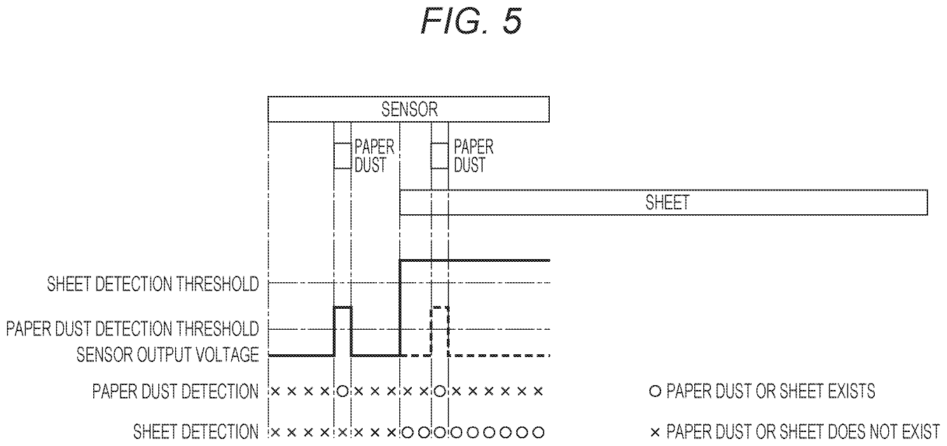

Next, FIG. 5 shows an example of a detection signal on the side end portion of the sheet P and paper dust by the detection part 740. As shown in FIG. 5, in the detection part 740, when the sheet P reaches the detection region, the sheet detection signal (the sensor output voltage indicated by the solid line) rises in the region in which the sheet P is detected, the sheet detection signal falls in the region in which the sheet P is not detected, and the result is transmitted to the control part 750 (see FIG. 4). The control part 750 detects the position of the side end portion on the side along the conveyance direction of the sheet P on the basis of the sheet detection signal output from the detection part 740 and the sheet detection threshold.

In the detection part 740, when paper dust exists in the detection region, the paper dust detection signal (the sensor output voltage indicated by the dotted line) rises in the region in which the paper dust is detected, the paper dust detection signal falls in the region in which the paper dust is not detected, and the result is transmitted to the control part (see FIG. 4). The control part 750 detects the presence position of the paper dust in the detection region on the basis of the paper dust detection signal output from the detection part 740 and the paper dust detection threshold.

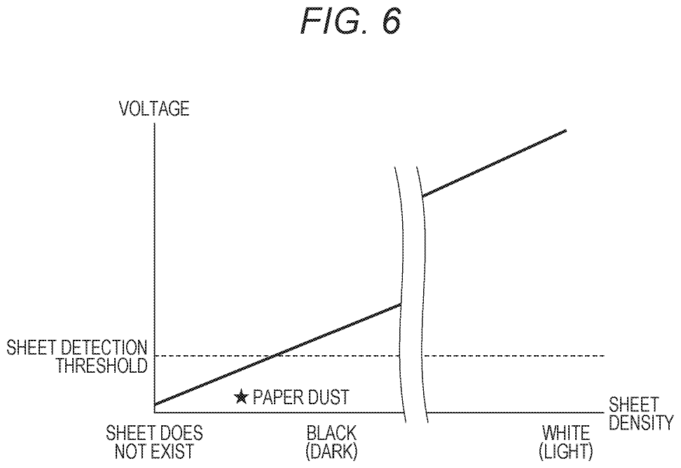

FIG. 6 shows a relationship of a detection signal (sheet detection signal, paper dust detection signal) output from the detection part 740, a sheet detection threshold, and a paper dust detection threshold. In FIG. 6, the vertical axis indicates the magnitude (voltage) of the detection signal from the detection part 740, and the horizontal axis indicates the sheet density of the sheet P. Note that the sheet density is an important factor affecting the intensity of the reflected light, and is, for example, a color element of the sheet P due to the color of the sheet itself, the toner density, the surface of the sheet (concavity and convexity, gloss, mat, or the like).

FIG. 6 shows a graph showing a change in the magnitude (voltage) of the sheet detection signal when the detection part 740 detects the sheet P, and shows the magnitude (voltage) of the paper dust detection signal when detecting the paper dust.

As shown in FIG. 6, the sheet detection signal output from the detection part 740 when detecting the side end portion of the sheet P becomes higher in a case where the sheet density of the sheet P is white (light), and becomes lower in a case where the sheet density is black (dark). Therefore, a case where the sheet density of the sheet P is single color of black is set to a criterion, and the sheet detection threshold used as a criterion when detecting the side end portion of the sheet P is set to a value lower than this criterion.

Furthermore, the paper dust detection signal output from the detection part 740 when paper dust is detected has a lower value than when the sheet density of the sheet P is single color of black. Therefore, the paper dust detection threshold as the criterion when paper dust is detected needs to be set to a value sufficiently lower than the sheet detection threshold using, as the criterion, the case where the sheet density of the sheet P is single color of black.

Therefore, as shown in FIG. 5, from the comparison between the sheet detection signal output from the detection part 740 and the sheet detection threshold, the position where the sheet detection signal (the sensor output voltage indicated by the solid line) is larger than the sheet detection threshold can be detected as a region in which the sheet P exists (circle in FIG. 5). Further, a position where the sheet detection signal is smaller than the sheet detection threshold can be determined as a region (cross in FIG. 5) in which the sheet P does not exist. Then, the boundary position between the region in which the sheet P exists and the region in which the sheet P does not exist can be detected as the side end portion of the sheet P.

On the other hand, in the paper dust detection, from the comparison between the paper dust detection signal output from the detection part 740 and the paper dust detection threshold, the position in which the paper dust detection signal (the sensor output voltage indicated by the dotted line) is larger than the paper dust detection threshold can be detected as a region in which paper dust exists (circle in FIG. 5).

Note that, when the detection of the sheet side end portion and the detection of paper dust are performed at the same time, in the case of paper dust existing in a region in which the sheet P exists, the detection signal of sheet detection and the detection signal of paper dust detection overlap with each other, so that the detection signal due to this paper dust cannot be detected. In this case, since paper dust can be detected only in the region in which the sheet P does not exist, the detection capability of the paper dust by the detection part 740 decreases. Therefore, it is preferable that the detection of the side end portion position of the sheet P and the detection of paper dust by the detection part 740 be performed at different timings. In particular, it is preferable that the paper dust detection be performed at the timing that the sheet P does not exist in the detection region of the detection part 740 so that the detection signals do not overlap with each other. As a result, it is possible to determine that the detection signal obtained at the timing when the sheet P does not exist is the detection signal of paper dust.

Further, it is more preferable that, when the punch processing is instructed, the paper dust detection be performed in advance before the sheet P reaches within the detection region of the detection part 740. While paper dust detection is being performed, in order to suppress errors of paper dust detection due to arrival of the sheet P or the like, it is preferable that the operation of the image forming apparatus 100 or the post-processors F other than the detection part 740 be stopped.

[Example of Operation of Image Forming System]

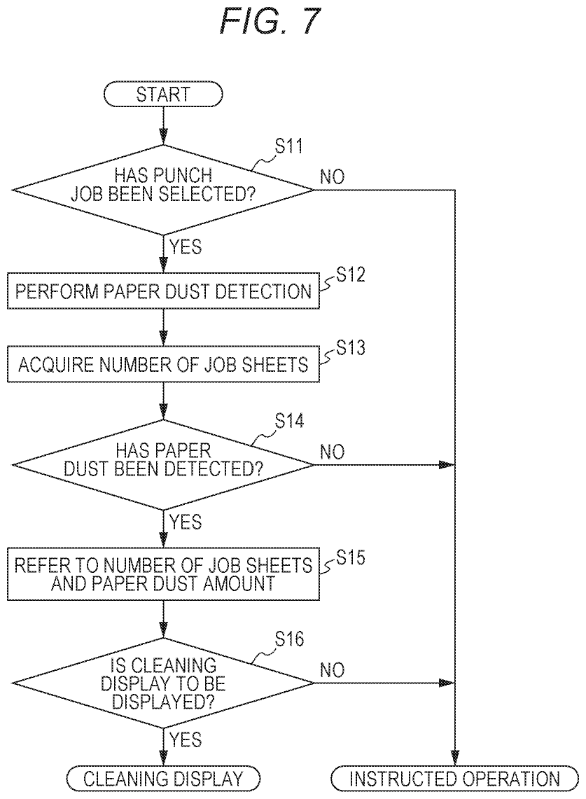

Next, an example of the paper dust detection operation in the image forming system GS will be described. FIG. 7 shows a flowchart of paper dust detection operation when punch processing is selected.

First, in the print job instructed by the user, the control part 750 determines whether the user has selected a punch job for performing punch processing on the sheet (step S11). When the punch job has been selected (Yes in step S11), the control part 750 instructs the detection part 740 to perform the paper dust detection (step S12). The control part 750 acquires information on the number of job sheets instructed by the user (step S13). When the punch job has not been selected (No in step S11), the image forming system GS performs a print job instructed by the user, and ends the processing according to this flowchart.

Next, after the detection part 740 performs the paper dust detection, the control part 750 determines whether paper dust has been detected in the detection region from comparison of the paper dust detection signal output from the detection part 740 with the paper dust detection threshold (step S14). When paper dust has not been detected (No in step S14), the image forming system GS performs a print job instructed by the user, and ends the processing according to this flowchart.

When paper dust has been detected (Yes in step S14), the control part 750 calculates an estimated paper dust amount in the punch unit 700 (see FIG. 2) from the paper dust detection signal output from the detection part 740. Further, the control part 750 refers to the calculated estimated paper dust amount and the number of job sheets acquired in step S13 (step S15), and determines whether a screen for instructing a user or the like to perform cleaning of the punch unit 700, on the basis of the estimated paper dust amount and information on the number of job sheets, is to be displayed on the operation display part 110 (see FIG. 4) of the image forming apparatus 100 (hereinafter, this screen display is referred to as “cleaning display”) (step S16).

The determination on whether the cleaning display is performed in step S16 is made on the basis of the estimated paper dust amount in the punch unit 700 estimated from the value of the magnitude (voltage V) of the detection signal from the detection part 740, the estimated paper dust amount in step S15, and information on the number of job sheets. The control part 750 changes the criterion of determination on whether the cleaning display is to be performed on the basis of the estimated paper dust amount calculated from the value of the magnitude (voltage V) of the detection signal and the acquired information on the number of job sheets.

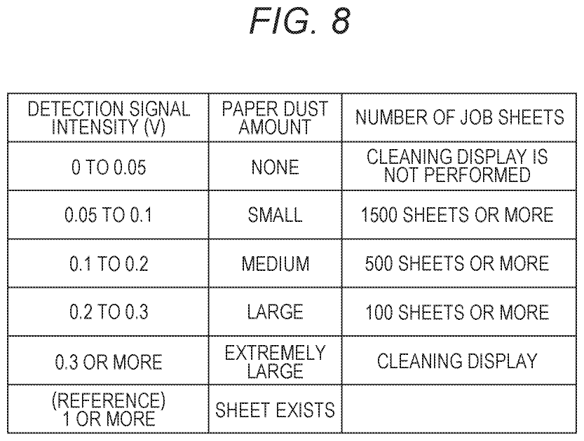

For example, as shown in FIG. 8, when the magnitude of the detection signal is 0 V or more and less than 0.05 V, it is determined that there is no paper dust in the punch unit 700 (the paper dust detection threshold or less). In this case, cleaning display is not performed irrespective of the number of job sheets.

When the magnitude of the detection signal is 0.05 V or more and less than 0.3 V, the paper dust amount in the punch unit 700 is calculated from the magnitude of the detection signal and an estimated paper dust amount is obtained. Then, whether or not the cleaning display is necessary is determined from the estimated paper dust amount and the number of job sheets. Specifically, as the number of job sheets increases, it is determined that the cleaning display is performed even with a detection signal having a smaller magnitude. In the punch unit 700, as the number of job sheets increases, the amount of paper dust generated from the start to the end of the job is larger. As the number of job sheets decreases, the amount of paper dust generated from the start to the end of the job is smaller. Therefore, erroneous detection of the side end portion position of the sheet P due to the generated paper dust is more likely to occur between the start and the end of the job as the number of job sheets increases. Accordingly, it is preferable that the reference value of the estimated paper dust amount for performing the cleaning display be set lower as the number of job sheets increases, and the cleaning display be performed so that the inside of the apparatus is cleaned in advance before the start of the job and the influence of the paper dust can be eliminated. On the other hand, when the number of job sheets is small, erroneous detection of the sheet P due to paper dust is unlikely to occur, so that the reference value of the estimated paper dust amount for performing the cleaning display can be increased so that the frequency of cleaning the inside of the apparatus can be reduced.

For example, when the magnitude of the detection signal is 0.3 V or more, it is determined that erroneous detection of the side end portion position of the sheet P due to paper dust is likely to occur since the paper dust amount in the apparatus is large, and the cleaning display is performed irrespective of the number of job sheets.

In FIG. 8, as an example of the magnitude of the sheet detection signal when the sheet P reaches the detection region, the magnitude of the detection signal when the sheet P is detected is shown as 1 V or more. That is, in the example shown in FIG. 8, when the magnitude of the detection signal is 1 V or more, it is determined that the sheet P has been detected, and therefore, the determination of whether the cleaning display is to be performed is not performed.

As described above, the control part 750 changes the criterion for determining whether the cleaning display is to be performed, on the basis of the execution result of the paper dust detection and the information on the number of job sheets. Then, when it is determined that the cleaning display is necessary (Yes in step S16) on the basis of the above-described information of the magnitude of the detection signal and the number of job sheets, the operation display part 110 (see FIG. 4) of the image forming apparatus 100 performs the cleaning display and ends the processing according to this flowchart. When it is determined that the cleaning display is not necessary (No in step S16), the image forming system GS performs a print job instructed by the user, and ends the processing according to this flowchart.

By the above-described operation of the image forming system GS, in the punch unit 700 of the post-processor F, sheet side end portion detection for detecting a side end portion in a main scanning direction orthogonal to the sheet conveyance direction, and paper dust detection for detecting the paper dust amount in a detection region can be performed. In addition, in the paper dust detection, when the paper dust amount is large, a screen for instructing the user or the like to perform cleaning of the inside of the punch unit 700 is displayed on the operation display part 110 (see FIG. 4) of the image forming apparatus 100, and the paper dust in the punch unit 700 is removed, so that erroneous detection of the sheet side end portion detection due to the paper dust can be suppressed. Therefore, it is possible to suppress the occurrence of erroneous detection of the sheet side end portion due to paper dust, and it is possible to suppress the decrease in productivity. Further, it is possible to more accurately detect the sheet side end portion and to form a punch hole at a more accurate position of the sheet P.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming system comprising:
an image forming apparatus that forms an image on a sheet; and
a post-processor coupled to a downstream side of the image forming apparatus and including a punch unit that forms a punch hole on the sheet conveyed from the image forming apparatus,
wherein the image forming apparatus comprises
a conveyance control part that controls conveyance of the sheet to be conveyed to the post-processor, and
the punch unit of the post-processor comprises:
a perforating part that forms the punch hole on the sheet;
a detection part that performs sheet side end portion detection for detecting a side end portion in a main scanning direction orthogonal to a conveyance direction of the sheet conveyed from the image forming apparatus using a predetermined detection threshold, and paper dust detection for detecting a paper dust amount in a detection region using a predetermined detection threshold;
a swinging part that moves the perforating part to an arbitrary position on the basis of a position of the side end portion of the sheet obtained by a detection result of the detection part; and
a hardware processor that, when a punch job is performed, controls the detection part to perform the paper dust detection using a timing different from a timing in the sheet side end portion detection, and a detection threshold different from the detection threshold in the sheet side end portion detection.

2. The image forming system according to claim 1, wherein the hardware processor performs the paper dust detection by the detection part before a punch hole is formed in the perforating part.

3. The image forming system according to claim 1, wherein operation of the image forming apparatus is stopped while the paper dust detection is being performed.

4. The image forming system according to claim 1, further comprising
a display part,
wherein the hardware processor causes the display part to display a screen for instructing a user to perform cleaning of an inside of the post-processor, from an execution result of the paper dust detection.

5. The image forming system according to claim 4,
wherein the hardware processor acquires information on a number of job sheets, and determines whether a screen for instructing the user to perform cleaning is to be displayed on the basis of the execution result of the paper dust detection and the acquired information on the number of job sheets.

6. The image forming system according to claim 5,
wherein the hardware processor calculates an estimated paper dust amount from the execution result of the paper dust detection, and determines whether a screen for instructing the user to perform cleaning is to be displayed on the basis of the calculated estimated paper dust amount and the information on the number of job sheets.

7. The image forming system according to claim 6,
wherein the hardware processor changes a criterion for determining whether a screen for instructing the user to perform cleaning is to be displayed on the basis of the estimated paper dust amount and the information on the number of jobs sheets.
